(19) United States
(12) Patent Application Publication
(10) Pub. No.: US 2013/0091009 A1
(43) Pub. Date: Apr. 11, 2013

(54) IDENTIFYING USERS LIKELY TO PERFORM FOR A SPECIFIC ADVERTISER'S CAMPAIGN GOALS

(71) Applicants: Vijay K. Narayanan, Mountain View, CA (US); Ashish Sumant, Mountain View, CA (US)

(72) Inventors: Vijay K. Narayanan, Mountain View, CA (US); Ashish Sumant, Mountain View, CA (US)

(73) Assignee: Yahoo! Inc., Sunnyvale, CA (US)

(21) Appl. No.: 13/270,845

(22) Filed: Oct. 11, 2011

(51) Int. Cl. G06Q 30/02

(52) U.S. Cl. 705/14.43

(57) ABSTRACT

Refining a target audience for an advertising campaign, includes: obtaining a seed list of customers; defining the target audience as the customers from the seed list who share key characteristics of a desired customer; formulating an audience model; using the audience model, generating a client-specific segment of the defined target audience for targeting; and optimizing the client-specific segment using conversion data.

### CROSS-REFERENCE TO RELATED APPLICATIONS

None.

### STATEMENT REGARDING FEDERALLY SPONSORED-RESEARCH OR DEVELOPMENT

None.

### INCORPORATION BY REFERENCE OF MATERIAL SUBMITTED ON A COMPACT DISC

None.

### FIELD OF THE INVENTION

The invention disclosed broadly relates to the field of Internet advertising, and more particularly relates to the field of user's online behavior with respect to Internet advertising.

### BACKGROUND OF THE INVENTION

In the world of Performance Advertising and Direct Response, advertisers are always looking to maximize conversions or clicks while minimizing the cost per action (“CPA”). The challenge is to sift through mountains of information available about users' online behavior and find just those users who are likely to click or convert for an advertiser's campaign. Advertisers want specific audiences at scale that meet a funnel stage objective. Also, advertisers want to connect to these target audiences with a strategy aimed at offering powerful audience definition, computation, and targeting capabilities. Because better targeting is the key to maximizing return on investment (“ROI”) for advertisers and minimizing risk. In brand advertising better targeting is the key to increasing reach for branders as they move more of their budget to online display.

### SUMMARY OF THE INVENTION

Briefly, according to an embodiment of the invention, a method for refining a target audience includes steps or acts of: obtaining a seed list of customers; defining the target audience as the consumers from the seed list who share key characteristics of a desired consumer; generating an audience model; using the audience model, generating a client-specific segment of the defined target audience for targeting; and optimizing the client-specific segment using conversion data.

According to another embodiment of the present invention, an information processing system includes the specific hardware embodiments to perform the method steps described above.

In yet another embodiment of the present invention, a computer-readable storage medium includes computer-executable program instructions for executing the method steps above.

The method can also be implemented as machine executable instructions executed by a programmable information processing system or as hard coded logic in a specialized computing apparatus such as an application-specific integrated circuit (ASIC).

### BRIEF DESCRIPTION OF THE SEVERAL VIEWS OF THE DRAWINGS

To describe the foregoing and other exemplary purposes, aspects, and advantages, we use the following detailed description of an exemplary embodiment of the invention with reference to the drawings, in which:

FIG. 1 is a high level block diagram showing an information processing system configured to operate according to an embodiment of the present invention;

FIG. 2 is a high level flowchart showing how Perform-Alike Targeting is implemented, according to an embodiment of the present invention; and

FIG. 3 is a simplified data flow diagram of a method for Perform-Alike Targeting, according to an embodiment of the present invention.

While the invention as claimed can be modified into alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention.

### DETAILED DESCRIPTION

Before describing in detail embodiments that are in accordance with the present invention, it should be observed that the embodiments reside primarily in combinations of method steps and system components related to systems and methods for placing computation inside a communication network. Accordingly, the system components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

We describe a mechanism to sift through millions of daily visitors to a website or network of websites and find those visitors who are likely to take a desired action for a ‘specific’ advertiser, based on several input parameters. The desired action can be a click, a conversion, a site visit, or a survey response, among others.

The input parameters are characteristics such as: a) the mathematically computed function of the specific websites the users visit; b) the content of those websites; c) the ads they have clicked on; d) the search queries they have input; e) social sharing activities such as “likes,” “shares,” replies to posts, and comments; and f) profile information such as demographics (age, gender, income, education) and online social connections.

The mathematical model we use can be one of a number of techniques including both linear and non-linear models. For example, a linear model is of the form:

$${y}_{i} = {\sum }_{i ∈ parameters} {w}_{i} * {x}_{i}$$

where yᵢ is the desired action, xᵢ is the parameter (also called the characteristic, and the weights wᵢ are learned using the historical observed data of this relationship.

Allowing marketers to specifically target an audience likely to convert or click helps the marketers meet their performance or direct response (DR) goals in a more cost-effective manner than traditional generic Behavioral or Demographic targeting.

Key Benefits.

Perform-Alike Targeting is the ability to target a scaled audience that shares characteristics with a subset of seed users and is optimized towards an advertiser's objective. The key benefits to Perform-Alike Targeting are:

1) Customizable—it delivers audiences that are specifically chosen to meet the marketer's goals;

2) Flexibility—it provides the ability to select from multiple campaign objectives;

3) Self-optimizing—it provides a closed loop, using campaign feedback to further customize;

The value provided can be different for different types of marketers. For example, for a performance advertiser, Perform-Alike Targeting delivers audience expansion so that the performance advertiser can get incremental acquisitions at an “acceptable” price, beyond the acquisitions already coming in through existing lines. Perform-Alike Modeling delivers audience optimization by narrowing the target audience by adding additional constraints that performance advertisers can use to improve the effective cost-per-acquisition or eCPA of their campaigns.

The needs and the target customers can vary. For one performance advertiser where its target customers are low-income individuals, it needs to maximize applications/conversions at the right price by targeting the specific audience to which the advertisement is aimed. For an emotional brander, the customers are not so easy to identify. The emotional brander needs to reach hard-to-find prospects at scale for its products.

Advantages.

1. Customized audience for a specific campaign performance goal (click or conversion).

2. Leverages a variety of data assets available to the network (for example, content on the network, user's behavior on the network including browsing, search and ads as well as related activities like views, clicks, and conversions, partner networks, online social profiles, social connections, demographic and geographic attributes of the user, memberships, user generated content, etc.)

3. This capability can be married with bid-prediction and creative optimization technologies to serve the right ad to the right users at the right time.

Advantages for Brand Advertising: better targeting is the key to increasing reach for branders as they move more of their budget to online display.

Product Features:

Perform-Alike Targeting:

a) expands an advertiser's target audience by identifying consumers that share key characteristics of their desired persona or their existing customers;

b) provides a choice of objectives to optimize—clicks/conversions/visits/survey responses; and

c) continuous audience tuning—provides a closed loop, with automatic updates to the generated target audience based on in-flight campaign performance.

d) allows for differentiation of campaign objectives: competitors deliver look alike audiences on behavior & profile similarity;

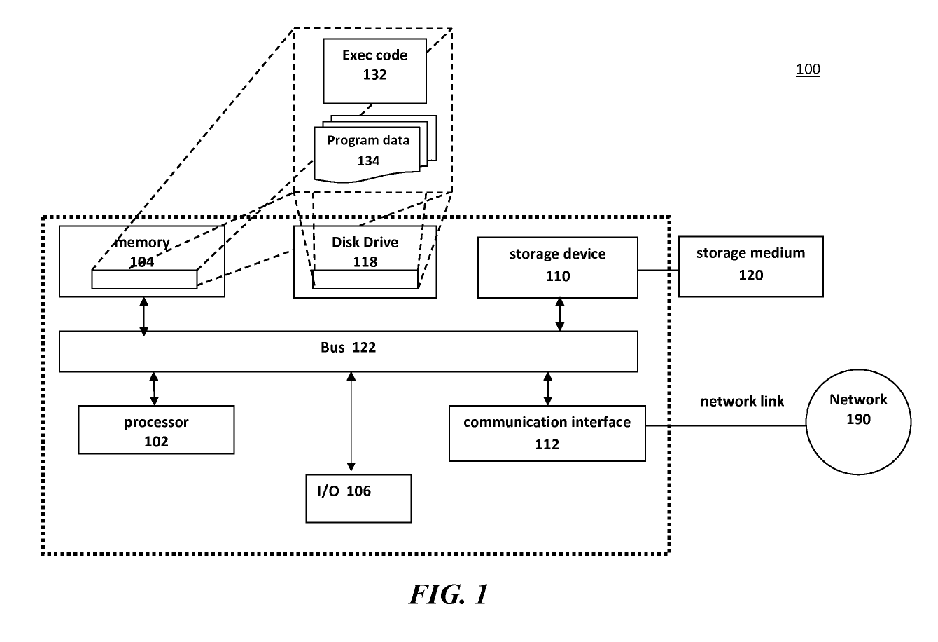

FIG. 1 System Embodiment.

Referring now in specific detail to the drawings, and particularly FIG. 1, there is provided a simplified pictorial illustration of an information processing system for Perform-Alike Targeting in which the present invention may be implemented. For purposes of this invention, computer system 100 may represent any type of computer, information processing system or other programmable electronic device, including a client computer, a server computer, a portable computer, an embedded controller, a personal digital assistant, and so on. The computer system 100 may be a stand-alone device or networked into a larger system. Computer system 100, illustrated for exemplary purposes as a networked computing device, is in communication with other networked computing devices (not shown) via network 110. As will be appreciated by those of ordinary skill in the art, network 110 may be embodied using conventional networking technologies and may include one or more of the following: local area networks, wide area networks, intranets, public Internet and the like.

In general, the routines which are executed when implementing these embodiments, whether implemented as part of an operating system or a specific application, component, program, object, module or sequence of instructions, will be referred to herein as computer programs, or simply programs. The computer programs typically comprise one or more instructions that are resident at various times in various memory and storage devices in an information processing or handling system such as a computer, and that, when read and executed by one or more processors, cause that system to perform the steps necessary to execute steps or elements embodying the various aspects of the invention.

Throughout the description herein, an embodiment of the invention is illustrated with aspects of the invention embodied solely on computer system 100. As will be appreciated by those of ordinary skill in the art, aspects of the invention may be distributed amongst one or more networked computing devices which interact with computer system 100 via one or more data networks such as, for example, network 110. However, for ease of understanding, aspects of the invention have been embodied in a single computing device—computer system 100.

Computer system 100 includes processing device 102 which communicates with an input/output subsystem 106, memory 104, storage 110 and network 110. The processor device 102 is operably coupled with a communication infrastructure 122 (e.g., a communications bus, cross-over bar, or network). The processor device 102 may be a general or special purpose microprocessor operating under control of computer program instructions 132 executed from memory 104 on program data 134. The processor 102 may include a number of special purpose sub-processors such as a comparator engine, each sub-processor for executing particular portions of the computer program instructions. Each sub-processor may be a separate circuit able to operate substantially in parallel with the other sub-processors.

Some or all of the sub-processors may be implemented as computer program processes (software) tangibly stored in a memory that perform their respective functions when executed. These may share an instruction processor, such as a general purpose integrated circuit microprocessor, or each sub-processor may have its own processor for executing instructions. Alternatively, some or all of the sub-processors may be implemented in an ASIC. RAM may be embodied in one or more memory chips.

The memory 104 may be partitioned or otherwise mapped to reflect the boundaries of the various memory subcomponents. Memory 104 may include both volatile and persistent memory for the storage of: operational instructions 132 for execution by CPU 102, data registers, application storage and the like. Memory 104 preferably includes a combination of random access memory (RAM), read only memory (ROM) and persistent memory such as that provided by a hard disk drive 118. The computer instructions/applications that are stored in memory 104 are executed by processor 102. The computer instructions/applications 132 and program data 134 can also be stored in hard disk drive 118 for execution by processor device 102. Memory 104.

The I/O subsystem 106 may comprise various end user interfaces such as a display, a keyboards, and a mouse. The I/O subsystem 106 may further comprise a connection to a network 190 such as a local-area network (LAN) or wide-area network (WAN) such as the Internet.

The computer system 100 may also include a removable storage drive 110, representing a floppy disk drive, a magnetic tape drive, an optical disk drive, etc. The removable storage drive 110 reads from and/or writes to a removable storage unit 120 in a manner well known to those having ordinary skill in the art. Removable storage unit 120, represents a floppy disk, a compact disc, magnetic tape, optical disk, CD-ROM, DVD-ROM, etc. which is read by and written to by removable storage drive 110. As will be appreciated, the removable storage unit 120 includes a non-transitory computer readable medium having stored therein computer software and/or data.

The computer system 100 may also include a communications interface 112. Communications interface 112 allows software and data to be transferred between the computer system and external devices. Examples of communications interface 112 may include a modem, a network interface (such as an Ethernet card), a communications port, a PCMCIA slot and card, etc. Software and data transferred via communications interface 112 are in the form of signals which may be, for example, electronic, electromagnetic, optical, or other signals capable of being received by communications interface 112.

In this document, the terms “computer program medium,” “computer usable medium,” and “computer readable medium” are used to generally refer to both transitory and non-transitory media such as main memory 104, removable storage drive 120, a hard disk installed in hard disk drive 118, and signals. These computer program products are means for providing software to the computer system 100. The computer readable medium 120 allows the computer system 100 to read data, instructions, messages or message packets, and other computer readable information from the computer readable medium 120.

Flowchart.

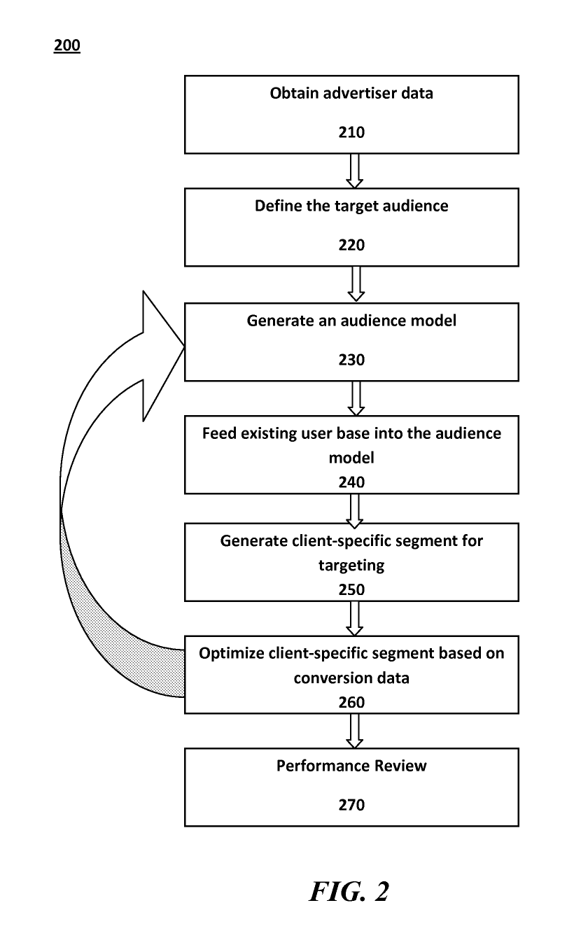

Referring to FIG. 2 we show a flowchart 200 of an implementation of Perform-Alike Targeting, according to an embodiment of the present invention. Generally it takes two to three weeks lead time to execute a campaign using Perform-Alike Targeting. Initially, advertiser data is obtained in step 210. The data can be collected from clients providing a list of existing customers or recent clickers/converters. Additionally, a client can instrument a web-site with pixels. When a user visits a web-site that is instrumented with a pixel (in JavaScript), this pixel fires, and sends information about the user visit (for example, the time of the visit, the activity that the user performs on that web-site, among other things) to another server. The other server then aggregates this data along with other information about the user.

Next, from this initial data, we define the target audience in step 220. We begin by generating a customer “seed list.” This is a preliminary list of existing customers. We refine this seed list by adding a marketer's audience objectives. These can be parameters such as segment size and/or optimization preference—click/conversion/visit. In this manner we define the audience that the advertiser wants.

Using the defined audience, in step 230 we generate an audience model. Next we feed the existing user base to the audience model to generate a filtered user base that conforms to the parameters of the model in step 240. Using the filtered user base, in step 250 we create a client-specific segment for targeting. For example, we output a set of users (cookies) that are identified by the model as belonging to the client-specific segment. This segment of users is expected to perform (or act) in a manner desired by the advertiser (for example, click or convert in the advertiser campaign).

Next, in step 260 we optimize the segment based on conversion data insights. These conversion data insights are also fed back into the model. Finally, in step 270 the advertising campaign concludes with a review of performance and campaign insights.

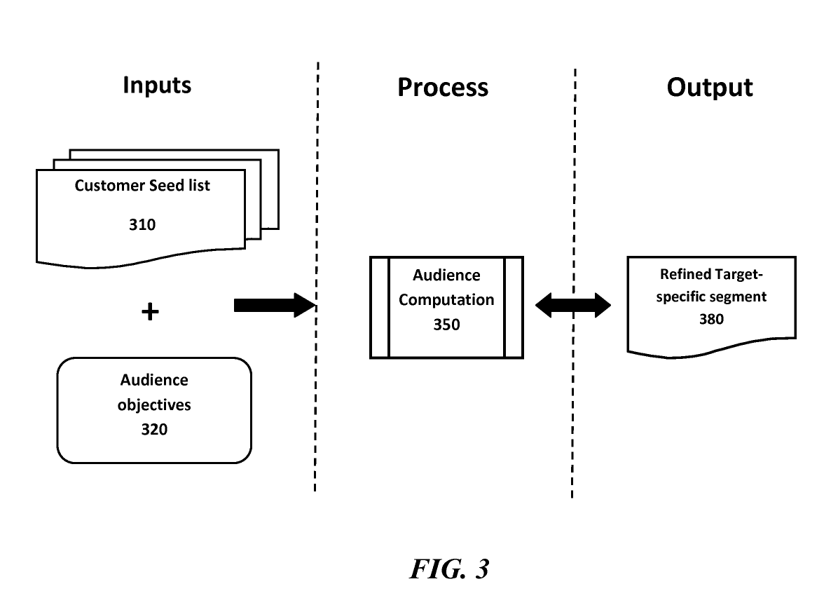

Referring now to FIG. 3 we show a simplified data flow of the process for performing Perform-Alike Targeting, according to an embodiment of the present invention. The inputs to the process are the customer seed list 310 and the audience objectives 320. It should be noted that because this methodology can be extended to other areas where it is beneficial to specify a target audience, the customer seed list 310 can be replaced by a charitable donor list, a patron of the arts list, and many others, within the spirit and scope of the invention. The process is the audience computation 350 that is performed first with the seed list 310 and the objectives 320. This same process is later refined with results of the output, the target-specific segment 380.

The objective of advertising campaigns is to acquire new/return customers. The seed list can be generated from recently acquired customers. The goal is three-fold: 1) needs to be ROI positive; 2) performance (conversion rate) lift over un-targeted baseline; and 3) find incremental users not targeted today. The approach is to run the ad alongside ongoing web-based advertising lines. We gauge the quality of the perform-alike segment over a baseline.

Monetization.

We monetize this targeting method by charging a premium for client-specific segments generated by look-alike targeting.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Therefore, while there has been described what is presently considered to be the preferred embodiment, it will understood by those skilled in the art that other modifications can be made within the spirit of the invention. The above description(s) of embodiment(s) is not intended to be exhaustive or limiting in scope. The embodiment(s), as described, were chosen in order to explain the principles of the invention, show its practical application, and enable those with ordinary skill in the art to understand how to make and use the invention. It should be understood that the invention is not limited to the embodiment(s) described above, but rather should be interpreted within the full meaning and scope of the appended claims.

We claim:

1. A method for refining a target audience for an advertising campaign, said method comprising steps of:
obtaining a seed list of customers;
defining the target audience as the customers from the seed list who share key characteristics of a desired customer;
formulating an audience model;
using the audience model, generating a client-specific segment of the defined target audience for targeting; and
optimizing the client-specific segment using conversion data.

2. The method of claim 1 further comprising a step of reviewing performance of the advertising campaign using the client-specific segment.

3. The method of claim 1 further comprising a step of feeding the conversion data from the optimizing step to the audience model.

4. The method of claim 1 wherein defining the target audience comprises filtering the seed list to extract users likely to take a desired action based on input parameters.

5. The method of claim 4 wherein the desired action comprises at least one of: a click, a conversion, a visit, and a survey response.

6. The method of claim 4 wherein the input parameters comprise a mathematically computed function of specific websites the users visit.

7. The method of claim 6 wherein the input parameters comprise content of the specific websites visited by the users.

8. The method of claim 4 wherein the input parameters comprise advertisements the users have clicked on.

9. The method of claim 4 wherein the input parameters comprise search queries input by the users.

10. The method of claim 4 wherein the input parameters comprise social sharing activities mined from social websites.

11. The method of claim 4 wherein the input parameters comprise profile information.

12. An information processing system for refining a target audience for an advertising campaign, said system comprising:
a memory comprising computer-executable instructions;
a network interface; and
a processor device operably coupled with the memory, said processor configured to cause a computer to perform:
obtaining a seed list of customers;
defining the target audience as the customers from the seed list who share key characteristics of a desired customer;
formulating an audience model;
using the audience model, generating a client-specific segment of the defined target audience for targeting; and
optimizing the client-specific segment using conversion data.

13. The information processing system of claim 12 wherein the processor device is further configured to review performance of the advertising campaign using the client-specific segment.

14. The information processing system of claim 12 wherein the processor device is further configured to feed the conversion data from the optimizing step to the audience model.

15. The information processing system of claim 12 wherein defining the target audience comprises filtering the seed list to extract users likely to take a desired action based on input parameters;
wherein the desired action comprises at least one of: a click, a conversion, a visit, and a survey response.

16. The information processing system of claim 15 wherein the input parameters comprise a mathematically computed function of specific websites the users visit.

17. The information processing system of claim 16 wherein the input parameters comprise content of the specific websites visited by the users.

18. The information processing system of claim 15 wherein the input parameters comprise at least one of: advertisements the users have clicked on, search queries input by the users, profile information about the users, and social sharing activities mined from social websites.

19. The information processing system of claim 12 wherein the obtaining, defining, formulating, generating, and optimizing are performed by one entity for another entity for a fee.

20. A computer program product comprising a computer-readable storage medium with instructions stored therein, said instructions causing a computer to perform:
obtaining a seed list of customers;
defining the target audience as the customers from the seed list who share key characteristics of a desired customer;
generating an audience model;
using the audience model, generating a client-specific segment of the defined target audience for targeting; and
optimizing the client-specific segment using conversion data.
